(19) United States
(12) Patent Application Publication
(10) Pub. No.: US 2026/0318260 A1
(43) Pub. Date: Oct. 15, 2026

(54) CYLINDER BLOCK FOR AN OPPOSED-PISTON ENGINE

(71) Applicant: General Atomics Aeronautical Systems, Inc., San Diego, CA (US)

(72) Inventor: Kevin B. Fuqua, Clarkston, MI (US)

(21) Appl. No.: 19/175,677

(22) Filed: Apr. 10, 2025

(51) Int. Cl. F02F 1/18; F02F 1/00; F02F 7/00

(52) U.S. Cl. CPC F02F 1/186; F02F 1/004; F02F 7/0009; F02F 7/0053

(57) ABSTRACT

A cylinder liner having an intermediate portion that is thicker than either of its two end portions can be installed in and removed from a cylinder block of an opposed-piston engine through a crankcase integral to the cylinder block, without splitting the cylinder block or detaching the crankcase. Access through the crankcase can be provided by way of an unobstructed aperture between complementarily-scalloped portions of two adjacent bulkheads that flank and define a space shaped to receive the cylinder liner.

### STATEMENT OF GOVERNMENT INTEREST

This Project Agreement Holder invention was first reduced to practice with U.S. Government support under Other Transaction Authority (OTA) Agreement No. W56HZV-22-9-C001 awarded by the U.S. Army Contracting Command. The Government has certain rights in the invention.

### FIELD

This disclosure relates generally to a cylinder block of an opposed-piston, internal combustion engine with two crankshafts.

### BACKGROUND

A multi-stroke cycle opposed-piston engine (hereinafter, “an opposed-piston engine”) has at least one cylinder (“a cylinder”) in the bore of which a pair of counter-moving pistons is disposed for reciprocating motion with their end surfaces facing. During operation of the engine, the pistons move in opposing directions, with their end surfaces approaching each other to form a combustion chamber in the bore during a compression stroke, and moving away from each other during an expansion stroke. Piston motion is delivered to at least one crankshaft (“a crankshaft”).

FIG. 1 is a schematic representation illustrating basic features of a prior art opposed-piston engine 10. The engine 10 includes a metal cylinder block 11 with a first crankcase 12, and a second crankcase 14. Bulkheads 13 (also called “webs”) extend transversely between opposite sides (not shown in FIG. 1) of the cylinder block 11. The cylinder block 11 includes a cylinder 16 and can include a plurality of cylinders 16 disposed in a row.

The row of cylinders 16 can be aligned with an elongate dimension L of the cylinder block 11. Taking the left-most cylinder 16 to be representative of all of the cylinders 16, each cylinder has a bore 18 and an annular intake portion including an intake port 20 separated along the longitudinal axis of the cylinder from an annular exhaust portion including an exhaust port 22. Each of the intake and exhaust ports includes one or more circumferential arrays of openings in which adjacent openings are separated by a bridge, which is a solid portion of the cylinder wall. In some descriptions, each opening may be referred to as a “port”; however, the construction of a circumferential array of such “ports” is no different than the port constructions in FIG. 1 in which the openings are referred to collectively as a port. The cylinders 16 are arranged such that their intake and exhaust portions are aligned on respective sides of the row. Two counter-moving pistons 30 and 32 are disposed in the liner bore of a cylinder with their end surfaces facing. The pistons 30 control the intake ports of the cylinders; the pistons 32 control the exhaust ports. A crankshaft 34 is rotatably supported by main bearings B1 along the intake portions of the cylinders 16, in parallel alignment with the elongate dimension L. All of the pistons 30 are coupled to the crankshaft 34. A crankshaft 36 is rotatably supported by main bearings B2 along the exhaust portions of the cylinders 16, in parallel alignment with the elongate dimension L. All of the pistons 32 are coupled to the crankshaft 36. Each bulkhead 13 supports a main bearing B1 on one end which supports the crankshaft 34 and a main bearing B2 on an opposite end which supports the crankshaft 36. The crankshafts 34, 36 can be coupled by a gear train 37 or by other equivalent means. The crankcase 12 houses the crankshaft 34 and the main bearings B1. The crankcase 14 houses the crankshaft 36 and the main bearings B2. The engine 10 can be referred to as a dual-crankshaft opposed-piston engine due to the presence of the two crankshafts 34 and 36. The engine structure can also include a gear box 38 housing the gear train 37.

In this specification, a “cylinder” of an opposed-piston engine is constituted of a liner (sometimes called a “sleeve”) disposed in a cylinder space (sometimes called a “tunnel”) defined between adjacent bulkheads of a cylinder block. Use of one or more cylinder liners (“a cylinder liner”) to finish cylinders lessens manufacturing issues associated with casting of metal cylinder blocks. In the opposed-piston engine of FIG. 1, each cylinder comprises a metal cylinder liner seated in a cylinder space defined between adjacent bulkheads 13 of the cylinder block 11.

The opposed-piston engine structure shown in FIG. 1 differs fundamentally from the inline and V-type structures of conventional multi-stroke engines in which a cylinder contains only a single piston and all pistons are connected to a single crankshaft. The structural differences are especially evident when considering the challenge of fitting the multi-cylinder opposed-piston engine structure of FIG. 1 to vehicle engine compartment space configured for conventional inline and V-type engine structures. Even if not constrained by predetermined engine compartment configurations, fitting the opposed-piston engine structure of FIG. 1 to a vehicle requires creative engineering. For example, it is important to make the opposed-piston engine structure as compact as possible so as to occupy minimal engine compartment space in applications including vehicles, locomotives, maritime vessels, aircraft, stationary power sources, and so on. It is particularly desirable to reduce the center-to-center spacing between the cylinders (i. e., “bore pitch”) so as to reduce the elongate dimension L of the cylinder block 11. There is, however, an impediment to this objective.

Combustion occurs in an intermediate portion of the cylinder liner when the end surfaces of pistons are near TC (“top center”) where the ends of the pistons are closest together. The high pressures and heat produced during combustion require construction details that strengthen the cylinders, especially around zones in their intermediate portions where the pistons are at or near TC. This presents challenges in cylinder block construction of opposed-piston engines that are altogether absent from a cylinder block of a conventional multi-stroke engine where the pressure and heat of combustion are contained between a piston and a cylinder head at one end of a cylinder.

In a multi-cylinder opposed-piston engine such as is illustrated by FIG. 1, the high heat transfer to the cylinder liner near TC can force the use of complex cooling passages and/or compression bands in the intermediate portion of the cylinder liner. Another difficulty is that the cylinder liner needs water cooled bridges between the exhaust ports for high brake mean effective pressure (BMEP) applications. Some or all of these features can result in cylinders that are thicker in their intermediate portions than typical 4 stroke diesel engine cylinders. In an inline opposed-piston configuration per FIG. 1, the intermediate portions align longitudinally, and their thickness limits the extent to which L can be reduced. A prior art cylinder liner with these features is shown in FIG. 2.

In FIG. 2, a prior art cylinder liner 40 is configured with intake and exhaust ports 43 and 45, respectively. The cylinder liner 40 has a generally tubular or cylindrical shape with a longitudinal axis 47; it comprises an intermediate portion 50 between end portions 44 and 46. The cylinder liner 40 has an outer surface with a diameter which varies axially between the end portions 44 and 46. The intermediate portion 50 has a generally cylindrical shape with an outer surface diameter D_{M} that is greater than a next largest outer diameter D_{E} of the outer surface of the two end portions 44 and 46. In other words, the thickness of the cylinder liner 40, measured from the longitudinal axis 47 to the outer surface of the liner, varies axially such that the intermediate portion 50 is thicker than either, or both, of the end portions 44 and 46. The cylinder space in which the liner 40 is seated must accommodate the largest outside diameter D_{M} (that is to say, the thickness) of the intermediate portion 50.

As a result, in multi-cylinder opposed-piston engine inline constructions, cylinder bore pitch is limited if inter-cylinder spacing is based on the outside diameter D_{M} of the intermediate portion of the cylinder liners plus the thickness of the bulkheads with which the liners are interspersed. A solution to this problem is described in the Applicant’s US publication 2016/0032861. Reduction of inter-cylinder pitch is obtained by reducing bulkhead thickness in the vicinity of the intermediate portions of the liners by designs which remove material from a bulkhead in its intermediate portion. “The structure of the bearing web members 242 accommodates the larger diameter of the middle portion of a cylinder tunnel without interposing the full thickness T of a web bearing member between adjacent tunnels.” US 2016/0032861, . However, the problem of how to insert and/or remove a cylinder liner with a thick intermediate portion in the resulting cylinder space is not so easily solved.

Insertion and removal of the cylinder liner 40 pose unique challenges to a cylinder block of an opposed-piston engine which are not encountered in conventional internal-combustion engines with cylinders in which a single piston reciprocates. In a conventional engine, a liner having a generally cylindrical sidewall surface with a generally uniform outside diameter along its length is received in the cylinder block where it is typically retained by a flange at its upper end which seats in a groove in the deck of the cylinder block where the cylinder head is attached. Insertion and removal of the liner are enabled through the deck when the cylinder head is removed; insertion and removal for this cylinder liner are unencumbered by a crankcase. In contrast, there is no cylinder head in an opposed-piston engine which can be removed to conveniently access a cylinder liner. In an opposed-piston engine embodiment comprising two crankshafts, each end of a cylinder opens to a respective one of two crankcases.

One solution to the problem of access is described in the ‘861 publication, wherein the opposed-piston engine comprises a cylinder block in which the cylinder block is split (i.e., physically divided) into two sections to permit a cylinder liner to be inserted into and removed from cylinder space in the cylinder block. A plane of separation between the two sections runs through the intermediate portions of the cylinders, thereby affording access for a cylinder liner with a thickened intermediate portion. According to the ‘861 publication, the plane of separation can run between the cylinder block and one of the crankcases. This construction, called “split-block”, requires disassembly of the cylinder block by removal of the crankcase therefrom in order to insert and/or retrieve a cylinder liner, with the cylinder liner being inserted or retrieved through the cylinder block, but not through the crankcase.

The split-block construction poses a number of drawbacks and difficulties. It requires a perimeter seal between the split sections to contain either coolant or crankcase oil (or both). The seal typically terminates in a T-joint, which is difficult to seal. In an opposed-piston engine with two crankshafts, in which the crankshafts are coupled by a gear train, the split-block construction adds a variable to geartrain tolerance stack-up which can influence backlash. A split-block construction increases part count, with extra fasteners required around the perimeter of the split. In the case where the split occurs between a crankcase and the cylinder block, access to cylinder space requires detaching and refastening a crankcase, which is a heavy, awkwardly-shaped element. Further, the mechanical coupling required to refasten the crankcase to the cylinder block may fail to prevent movement between these elements during operation of the engine.

It is desirable to avoid the drawbacks of a split-block configuration by employing a construction in which the cylinder block and crankcases constitute a single, integral unit formed, for example, by a metal casting process, which includes bulkheads and walls defining cylinder tunnels and crankcase spaces. However, the forming process, especially casting, may not be able to achieve the precision necessary for forming small holes and narrow passages as may be required for delivery and transport of liquid coolant to and through a cylinder. In such cases it may be desirable to retain a liner-based cylinder construction. The problem addressed by the present disclosure is how to place and retrieve a cylinder liner with a thick intermediate portion in an opposed-piston engine without splitting the cylinder block or removing a crankcase therefrom.

The innovative insight is that a cylinder liner having a diameter D_{M} in its intermediate portion that is greater than a next-largest outer diameter D_{E} of either of its two end portions can be installed in and removed from a cylinder block of an opposed-piston engine through a crankcase integral to the cylinder block, without splitting the cylinder block or detaching the crankcase. Access through the crankcase can be provided by way of an aperture between complementarily-scalloped portions of two adjacent bulkheads that flank and define a space shaped to receive the cylinder liner. In the absence of main bearings on the bulkheads, the scalloping defines and provides an unobstructed aperture at (in or near) the crankcase that is large enough to allow passage of the large diameter of the intermediate portion of the liner through the crankcase of the cylinder block, thereby enabling insertion and removal of the cylinder liner without splitting the cylinder block or removing the crankcase. When assembled to the bulkheads, the main bearings overlay the complementary scalloping, thereby obstructing (effectively, blocking) the aperture so as to retain the cylinder liner in the cylinder space defined between the bulkheads.

### SUMMARY

An objective of the innovative embodiments described herein is to provide a cylinder block of an opposed-piston engine in which a cylinder liner can be inserted into, and/or removed from, the cylinder block through a crankcase which is integral with the cylinder block, thereby not requiring a split-block construction or removal of the crankcase.

According to this disclosure, a pair of bulkheads can be configured by complementary scalloping or shaping of their end portions to define an aperture at the crankcase through which a cylinder liner having a thickened intermediate portion can be inserted into, or removed from, cylinder space defined between the bulkheads. The aperture is unobstructed when main bearing devices are removed from the pair of bulkheads, and is obstructed or blocked by attachment of the main bearing devices to the pair of bulkheads.

Each main bearing device comprises a complete main bearing which is removably attached or secured to an end portion of a bulkhead. A main bearing device can be constituted of two separate pieces that are joined or attached together to form a cylindrical bearing recess having a generally circular shape, and are configured to be secured to a scalloped or shaped end portion of a bulkhead. For purposes of explanation, these pieces are termed “saddle” and “cap” to denote the positional relationship of the saddle and cap pieces with respect to a scalloped or shaped end portion of a bulkhead on which the main bearing device is received. In this regard, the saddle piece is the main bearing piece that is configured to be in contact with the scalloped or shaped end portion and the cap piece is received on and coupled, joined, assembled, or attached to the saddle piece.

According to this disclosure, each main bearing device can be configured to be removably mounted to a scalloped or shaped end portion of a bulkhead such that when each main bearing device is removed from the scalloped or shaped end portion of the respective one of the pair of bulkheads, the aperture is unobstructed ed so as to permit a cylinder liner to be inserted into the cylinder space.

Conversely, when each of the main bearing devices is mounted to the scalloped or shaped end portion of a respective one of the pair of bulkheads, the aperture is blocked or obstructed so as to retain a cylinder liner in the cylinder space.

In some embodiments , a cylinder block of an opposed-piston engine comprises at least one bulkhead (“a bulkhead”) with a scalloped or shaped end portion positioned at a crankcase which is integral with the cylinder block. The scalloped end portion is configured to support a crankshaft main bearing which can include a saddle piece having a receiving surface with a first semi-cylindrical bearing recess, and having an attachment surface opposite the receiving surface and received on the scalloped end portion, and a cap piece having a seating surface with a second semi-cylindrical bearing recess, in which the seating surface is configured to be received on the receiving surface such that the second semi-cylindrical bearing recess and the first semi-cylindrical bearing recess align to define a cylindrical bearing recess for a main journal of a crankshaft. Accordingly, the entire main bearing itself can be attached to and detached from the cylinder block, thereby enabling access to cylinder space for insertion and/or retrieval of a cylinder liner, without splitting the cylinder block or detaching the crankcase from the cylinder block.

### BRIEF DESCRIPTION OF DRAWINGS

FIG. 1 schematically illustrates a cylinder block of an opposed-piston engine, and is appropriately labeled “Prior Art”.

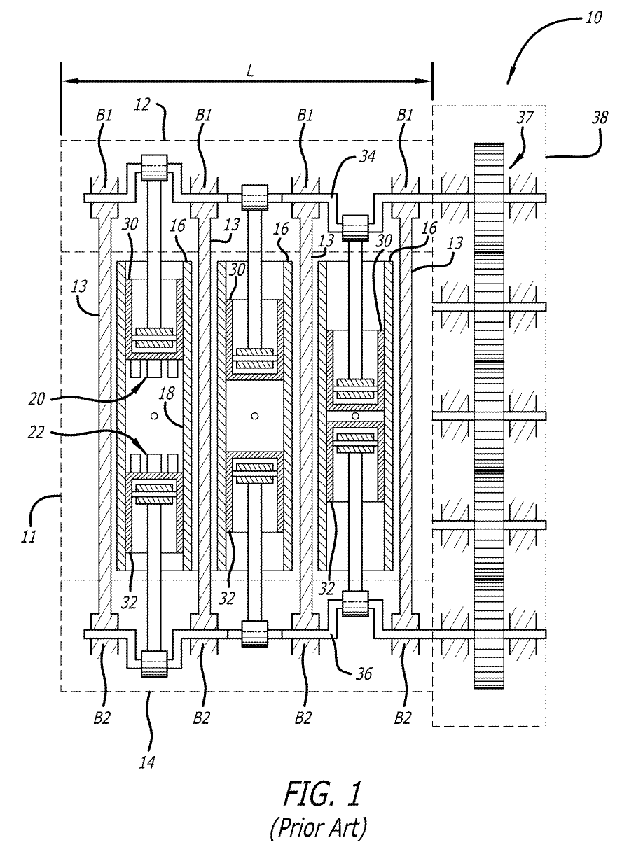

FIG. 2 illustrates a cylinder liner of an opposed-piston engine, and is appropriately labeled “Prior Art”.

FIG. 3 is a front elevation view in cross-section of a main bearing device.

FIG. 4 is a front elevation view partly in cross-section of a portion of an opposed-piston engine cylinder block with a main bearing device.

FIG. 5A is an end view of a saddle piece of a main bearing device showing an attachment surface;

FIG. 5B is an end view of a bulkhead showing scalloping of an end portion of the bulkhead;

FIG. 5C is a plan view of the saddle piece overlaying the scalloped end portion of the bulkhead.

FIGS. 6A-6K are schematic drawings illustrating exemplary embodiments.

FIGS. 7A and 7B are views into a crankcase of an opposed-piston engine.

### DETAILED DESCRIPTION

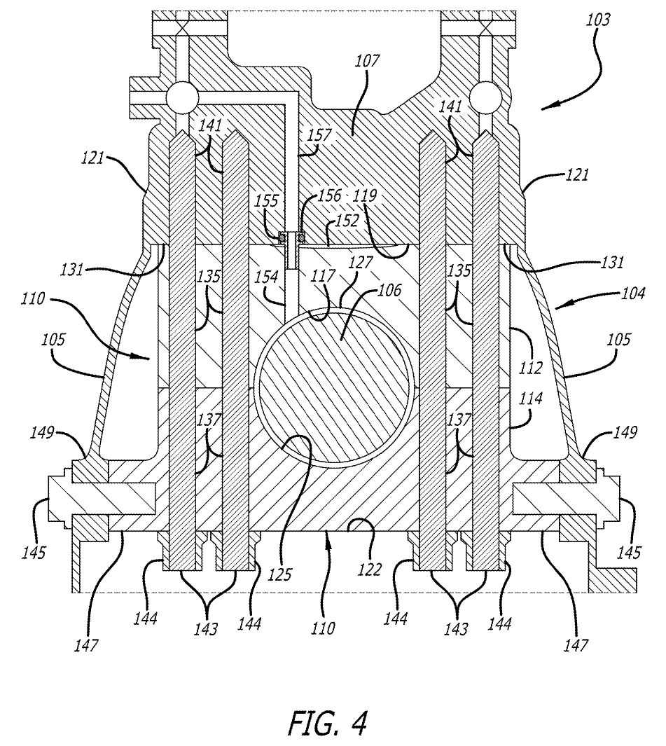

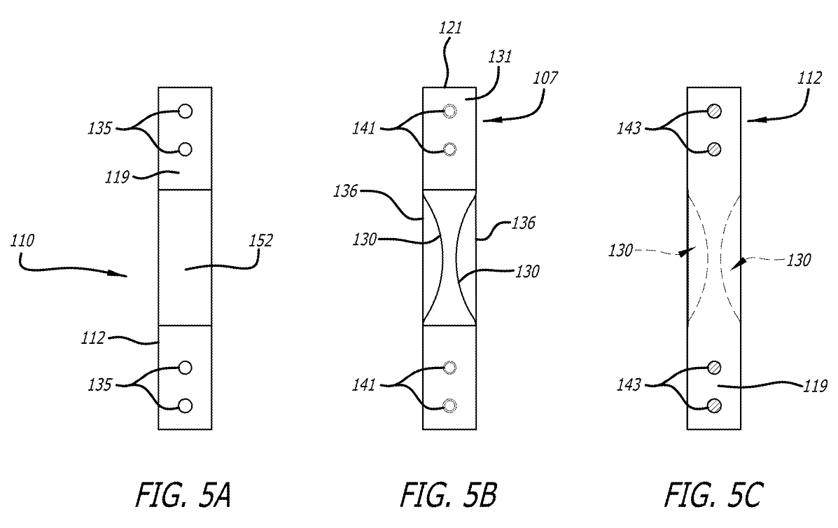

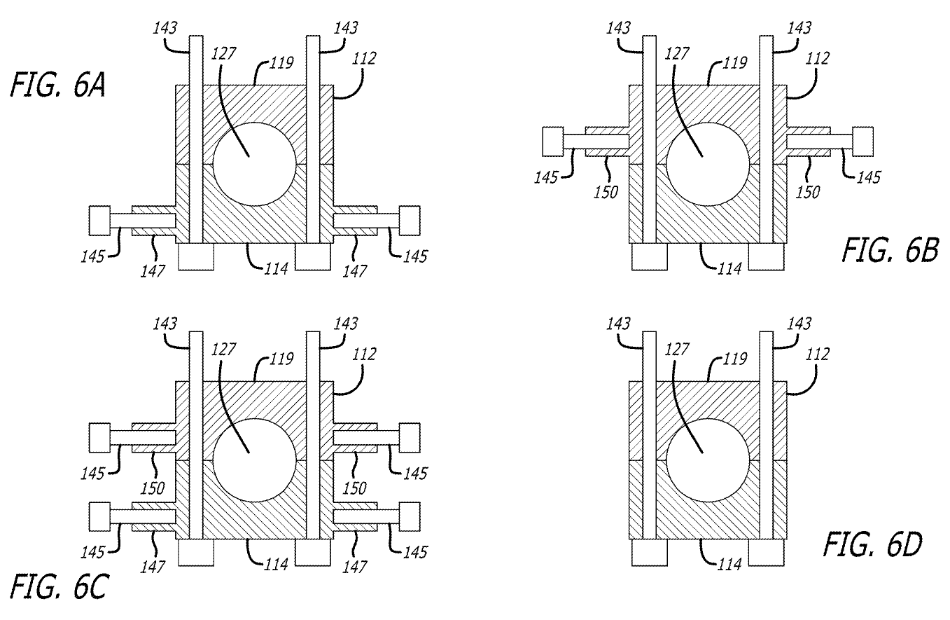

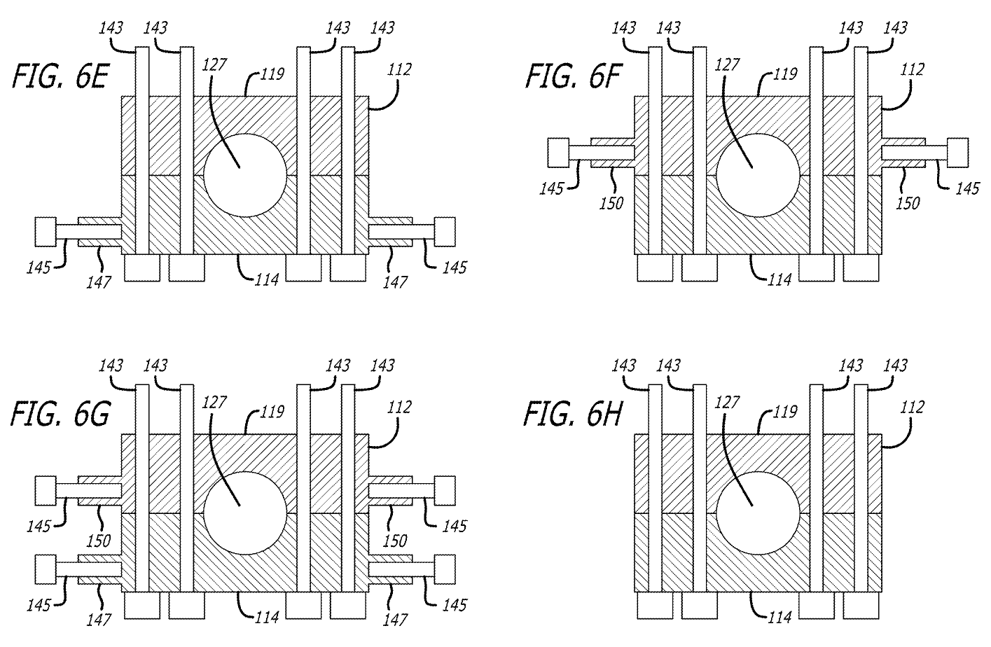

Main bearings are bearings disposed in crankcase space of a cylinder block which retain a crankshaft on the cylinder block and permit the crankshaft to rotate. Each main bearing receives a main journal of the crankshaft. A main bearing of an opposed-piston engine according to the prior art has features corresponding to those shown in FIGS. 4 and 5 of the Applicant’s US ‘861 publication, where an end of a bulkhead of a cylinder block has a semi-cylindrically shaped bearing recess in a main bearing pedestal portion. A separate main bearing cap with a complementary semi-cylindrically shaped bearing recess completes a main bearing which receives a main journal of a crankshaft. “The main bearing caps … are secured over the main bearing pedestal portions … by threaded fasteners … so as to rotatably support the crankshaft”. US 2016/0032861, . In the opposed-piston engine of the ‘861 publication, one half of the main bearing – the bearing pedestal portion with a semi-cylindrically-shaped bearing recess - is formed on, and is integral with, an end of a bulkhead; in other words, the pedestal portion (I.e., the saddle piece) of the main bearing cannot be removed from or attached to the end of the bulkhead. The specification and claims which follow herein are directed to a unique main bearing device that is distinct from and different than the main bearing construction of the opposed-piston prior art represented by the ‘861 publication.

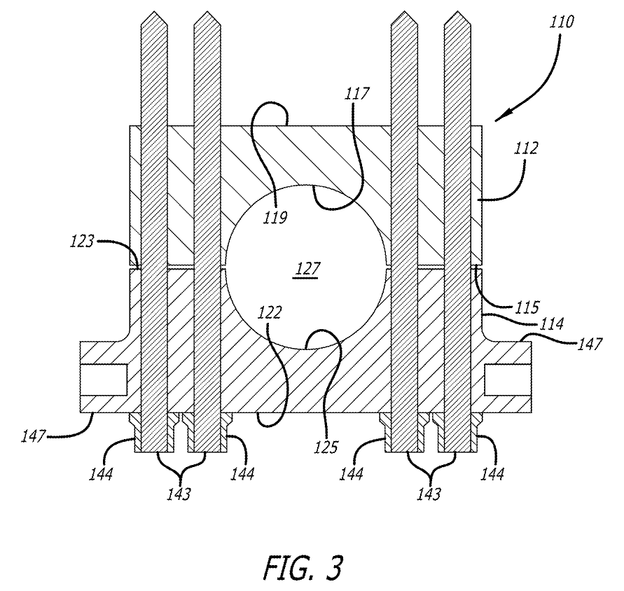

With respect to FIGS. 3 and 4, an opposed-piston engine includes a lower portion of a cylinder block 103. Opposing sidewalls 105 of the cylinder block define a crankcase 104 comprising a crankcase cavity in which a crankshaft rotates. The crankshaft includes a plurality of main journals one of which is indicated by 106. A bulkhead 107 on the cylinder block 103 supports a main bearing device 110.

The main bearing device 110 comprises a saddle piece 112 and a cap piece 114. The saddle piece 112 has a receiving surface 115 with a first semi-cylindrical bearing recess 117. A rectangularly shaped attachment surface 119 extends across a base of the of the saddle piece, opposite the receiving surface 115. The attachment surface 119 is configured to assemble to, and to be retained on, an end portion 121 of the bulkhead 107. The cap piece 114 has a top surface 122 and an opposite seating surface 123 with a second semi-cylindrical bearing recess 125. The seating surface 123 of the cap piece is received on the receiving surface 115 of the saddle piece. In this manner, the first and second semi-cylindrical bearing recesses 117 and 125 can be aligned to define a cylindrical bearing recess 127. In some embodiments, bosses 147 projecting from opposite sides of the cap piece 114 can be provided.

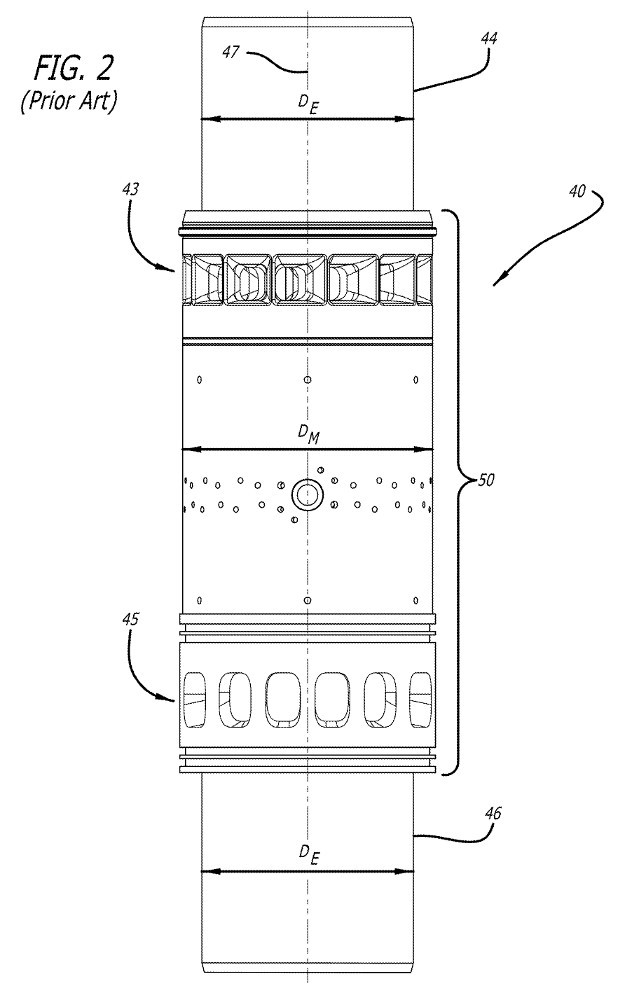

As shown in the FIGS. 5A-5C, a main bearing apparatus can incorporate the main bearing device 110 with the scalloped end 121 of a bulkhead 107. FIG. 5A is a plan view of the base of the saddle piece 112, which shows the configuration of the attachment surface 119 to be an area with a generally rectangular shape. FIG. 5B is a plan view of the joint surface 131 of the bulkhead 107 showing scalloping 130 which extends longitudinally on the bulkhead from the joint surface 131 to a stopping feature 136 on an inner diameter of the cylinder space where the diameter of the cylinder liner transitions from D_{M} to D_{E}. Both sides of the end portion 121 can be scalloped as seen in FIG. 5B. An elongate trench, defined by the scalloping 130 can have a partially-circular cross-sectional shape characterized by an effective diameter sufficient to permit the diameter D_{M} of the intermediate portion of a cylinder liner such as the cylinder liner 40 seen in FIG. 2 to be received in the cylinder space formed in part by the bulkhead 107. Thus, the scalloped shape of the end portion 121 of the bulkhead 107 defines or provides at least a portion of a generally circular aperture large enough to allow passage of a cylinder liner according to FIG. 2 into the cylinder block, through the crankcase cavity between opposing sidewalls 105 seen in FIG. 3, without splitting the block or removing the crankcase therefrom. As per FIG. 5C, the generally rectangular shape of the attachment surface 119 configures the base of the saddle piece 112 to overlay the scalloping 130. When the base of the saddle piece 112 overlays the scalloped end portion 121, the portion of the generally circular aperture formed by the scalloping is obstructed or blocked, thereby configuring the main bearing device 110 to anchor, secure, retain, or otherwise hold a cylinder liner in the cylinder space defined between the bulkhead 107 and an adjacent bulkhead.

It should be evident that scalloping results in loss of material to support a bearing race. However, as per FIG. 5C, when the main bearing device 110 is received on and secured to the scalloped end portion 121, the rectangular shape of the attachment surface 119 replaces material lost to scalloping so that an inner bearing race can be fully supported in the cylindrical bearing recess 127.

Referring to FIGS. 3, 4, and FIG. 5A- 5C, a plurality of fasteners are provided to join the saddle piece with the cap piece, and secure the joined saddle piece and cap piece to the cylinder block when the attachment surface is received on the scalloped end portion of a bulkhead. Such fasteners may comprise studs or bolts. Although studs are used to illustrate the form and function of fasteners in the following description, a person having ordinary skill in the art would recognize that bolts can also fill the role of fasteners.

Stud insertion holes 135 are provided (e.g., drilled, cast, etc.) through the saddle piece 112 from the receiving surface 115 to the attachment surface 119. At least one stud insertion hole 135 is provided on each side of the first semi-cylindrical bearing recess 117. In some embodiments, four stud insertion holes 135 can be provided through the saddle piece 112, two on each side of the first semi-cylindrical bearing recess 117. Stud insertion holes 137 are drilled through the cap piece 114 from the seating surface 123 to the top surface 122. At least one stud insertion hole 137 is provided on each side of the second semi-cylindrical bearing recess 125. As per the embodiment shown in FIG. 3, four stud insertion holes 137 are provided through the cap piece 114, two on each side of the second semi-cylindrical bearing recess 125.

The main bearing device 110 is assembled to the cylinder block 103. In some embodiments, the main bearing device 110 can be assembled to the scalloped end portion 121 of the bulkhead 107, with the attachment surface 119 of the saddle piece 112 contacting the joint surface 131, and the seating surface 123 of the cap piece 114 contacting the receiving surface 115 of the saddle piece 112. In this example, the first semi-cylindrical bearing recess 117 and the second semi-cylindrical bearing recess 125 align to define the cylindrical bearing recess 127. The bearing recess 127 is configured to receive a main bearing race (not shown), whereby, the cylindrical shape of the bearing recess can accommodate and retain the main journal 106.

Assembly of the main bearing device 110 aligns the stud insertion holes 135 and 137 with each other and with complementary holes 141 formed in the bulkhead 107. A plurality of studs are provided to join the saddle piece 112 with the cap piece 114 and to secure the joined saddle piece and cap piece to the cylinder block 103. In this regard, the studs can join the saddle piece 112 with the cap piece 114 and secure the joined saddle piece and cap piece to the bulkhead 107 when the attachment surface 119 is received on the scalloped end portion 121. At least two studs 143 can be configured to pass through the stud insertion holes 132, the stud insertion holes 137, and into the bulkhead 107 via the drilled holes 141, with one stud on each side of the bearing recess. In some embodiments, the studs 143 can be of a stud length sufficient to reach from the top surface 122 of the cap piece 114 (or from the receiving surface 123 of the saddle piece 112) at least to the drilled holes 141. The first end of each stud 143 can be coupled to the cap piece 114 (or the saddle piece 112) by a nut 144 and threading of the second end of each stud 143 so as to be engaged by threading in the drilled hole 141. In some embodiments, four studs 143, two on each side of the cylindrical bearing recess 127, join the saddle piece 112 with the cap piece 114, and secure the joined saddle and cap pieces to the bulkhead 107 when the attachment surface 119 is received on the scalloped end portion 121.

Cross-bolts configured to act between the main bearing device 110 and the opposing walls 105 can be provided to stabilize the main bearing device in the crankcase cavity. Relatedly, a cross-bolt is a bolt retaining a bearing piece on a side of a crankshaft main journal that is oriented in a direction generally perpendicular to the axis of the crankshaft. As per FIGS. 3 and 4, cross-bolts 145 can be provided in the crankcase cavity defined between the opposing sidewalls 105. In such embodiments, laterally oriented, oppositely directed bosses 147 with threaded recesses can be provided on opposing sidewalls of the cap piece 114, which extend toward the opposing sidewalls 105, where they can be aligned with complementary bosses 149 formed in the crankcase sidewalls. The configuration of the cross-bolts 145 can include threading at their ends, which can then be inserted through the complementary bosses and tightened into the threaded recesses of the bosses 147 of the cap piece 114.

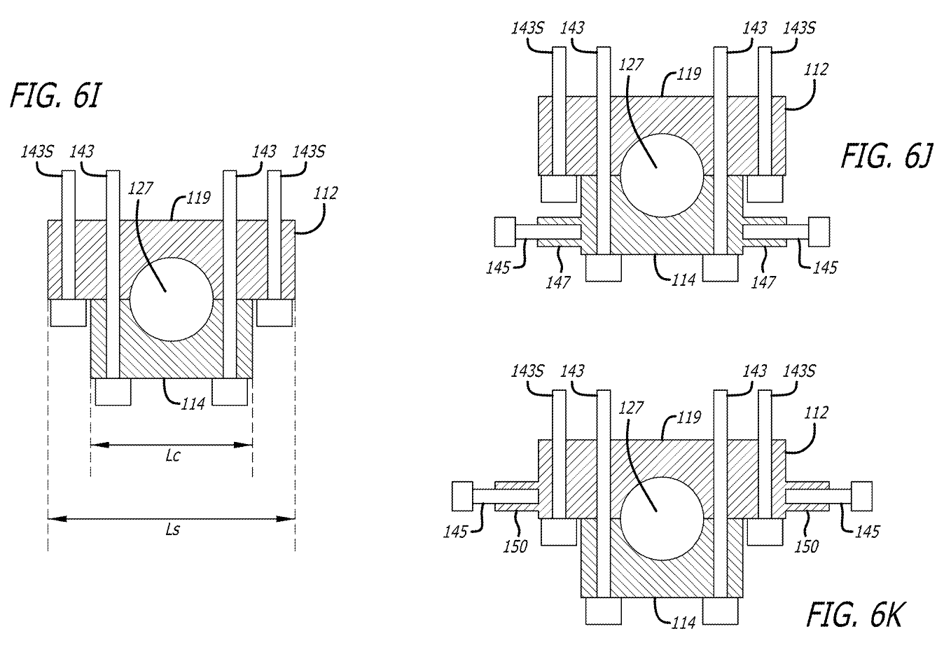

FIGS. 6A-6K are schematic drawings which illustrate various embodiments for fastening the saddle piece 112 to the cap piece 114 and securing the main bearing device 110 to the cylinder block 103.

As per FIG. 6A, two studs 143, one on each side of the cylindrical bearing recess 127, join the saddle piece 112 with the cap piece 114, and secure the joined saddle piece and cap piece to the bulkhead 107 when the attachment surface 119 is received on the scalloped end portion 121 of the bulkhead. Two cross-bolts 145 extending through the opposing sidewalls of the crankcase are tightened into the threaded recesses of the bosses 147 of the cap piece 114.

As per FIG. 6B, two studs 143, one on each side of the cylindrical bearing recess 127, join the saddle piece 112 with the cap piece 114, and secure the joined saddle piece and cap piece to the bulkhead when the attachment surface 119 is received on the scalloped end portion 121. Two cross-bolts 145 extending through the opposing sidewalls of the crankcase are tightened into the threaded recesses of bosses 150 formed on opposing sides of the saddle piece 112.

As per FIG. 6C, two studs 143, one on each side of the cylindrical bearing recess 127, join the saddle piece 112 with the cap piece 114, and secure the joined saddle piece and cap piece to the bulkhead when the attachment surface 119 is received on the scalloped end portion 121. Two cross-bolts 145 extending through the opposing sidewalls of the crankcase are tightened into the threaded recesses of the bosses 147 of the cap piece 114. Two cross-bolts 145 extending through the opposing sidewalls of the crankcase are tightened into the threaded recesses of bosses 150 formed on opposing sides of the saddle piece 112.

As per FIG. 6D, two studs 143, one on each side of the cylindrical bearing recess 127, join the saddle piece 112 with the cap piece 114, and secure the joined saddle piece and cap piece to the bulkhead when the attachment surface 119 is received on the scalloped end portion 121. No cross-bolts are used in this embodiment.

As per FIG. 6E, four studs 143, two on each side of the cylindrical bearing recess 127, join the saddle piece 112 with the cap piece 114, and secure the joined saddle piece and cap piece to the bulkhead when the attachment surface 119 is received on the scalloped end portion 121. Two cross-bolts 145 extending through the opposing sidewalls of the crankcase are tightened into the threaded recesses of the bosses 147 of the cap piece 114. This corresponds to the fastening/securing embodiment shown in FIGS. 3 and 4.

As per FIG. 6F, four studs 143, two on each side of the cylindrical bearing recess 127, join the saddle piece 112 with the cap piece 114, and secure the joined saddle piece and cap piece to the bulkhead when the attachment surface 119 is received on the scalloped end portion 121. Two cross-bolts 145 extending through the opposing sidewalls of the crankcase are tightened into the threaded recesses of bosses 150 formed on opposing sides of the saddle piece 112.

As per FIG. 6G, four studs 143, two on each side of the cylindrical bearing recess 127, join the saddle piece 112 with the cap piece 114, and secure the joined saddle piece and cap piece to the bulkhead when the attachment surface 119 is received on the scalloped end portion 121. Two cross-bolts 145 extending through the opposing sidewalls of the crankcase are tightened into the threaded recesses of the bosses 147 of the cap piece 114. Two cross-bolts 145 extending through the opposing sidewalls of the crankcase are tightened into the threaded recesses of bosses 150 formed on opposing sides of the saddle piece 112.

As per FIG. 6H, four studs 143, two on each side of the cylindrical bearing recess 127, join the saddle piece 112 with the cap piece 114, and secure the joined saddle piece and cap piece to the bulkhead when the attachment surface 119 is received on the scalloped end portion 121. No cross-bolts are used in this embodiment.

As per FIG. 6I, two studs 143, one on each side of the cylindrical bearing recess 127, can secure the joined saddle piece 112 and cap piece 114 to a bulkhead when the attachment surface 119 is received on the scalloped end portion of the bulkhead. In addition, two studs 143S can secure the assembled main bearing device 110 to the scalloped end portion of the bulkhead. As the view indicates, the saddle piece 112 has a length (Ls) which is greater than the corresponding length (Lc) of the cap piece 114, thereby providing projections on both sides of the saddle piece 112 that jut out beyond corresponding ends of the cap piece 114. These projections support the two studs 143S which only pass through the saddle piece 112 and can be threaded into complementary drilled, threaded holes in the bulkhead.

As per FIG. 6J, two studs 143, one on each side of the cylindrical bearing recess 127, can secure the joined saddle piece 112 and cap piece 114 to a bulkhead when the attachment surface 119 is received on the scalloped end portion of the bulkhead. In addition, two studs 143S can secure the assembled main bearing device 110 to the scalloped end portion of the bulkhead. Two cross-bolts 145 can extending through the opposing sidewalls of a crankcase to be tightened into the threaded recesses of the bosses 147 of the cap piece 114.

As per FIG. 6K, four studs 143 and 143S, two (143 and 143S) on each side of the cylindrical bearing recess 127, can secure the joined saddle piece 112 and cap piece 114 to a bulkhead when the attachment surface 119 is received on the scalloped end portion of the bulkhead. In addition, two of the studs 143 join the saddle piece 112 with the cap piece 114 as per FIG. 6I. Two cross-bolts 145 can extend through the opposing sidewalls of a crankcase to be tightened into the threaded recesses of the bosses 150 of the saddle piece 112.

Referring again to FIGS. 4 and 5A, the main bearing device 110 may include additional elements. One additional element can be provided to mitigate the risk of fretting at the interface between the attachment surface 119 of the saddle piece 112 and the bulkhead joint surface 131. The attachment surface 119 (or the joint surface 131) can be shaped slightly with, for example, a shallow concavity or arch 152 between the sets of studs 143 in order to concentrate stress at the area of contact between the attachment surface 119 and the bulkhead 107 to the studs 143.

In order to enable lubrication of the main bearing device 110, the saddle piece 112 can further comprise a passageway 154 to transport oil from a lubricant passageway 157 formed in the bulkhead 107 to the cylindrical bearing recess 127. As shown in the figures the passageway 154 can extend through the saddle piece 112, from the attachment surface 119 to the first semi-cylindrical opening 117. In the event that the attachment surface 119 is shaped, as with the arch 152, a radially compressed O-ring 155 can be provided on a perimeter of a tube 156 configured to provide a flow passage from the lubricant passageway 157 to the passageway 154 at the attachment surface 119. The O-ring 155 can seal the passageway 154 should there be insufficient clamping load to use a simple face seal.

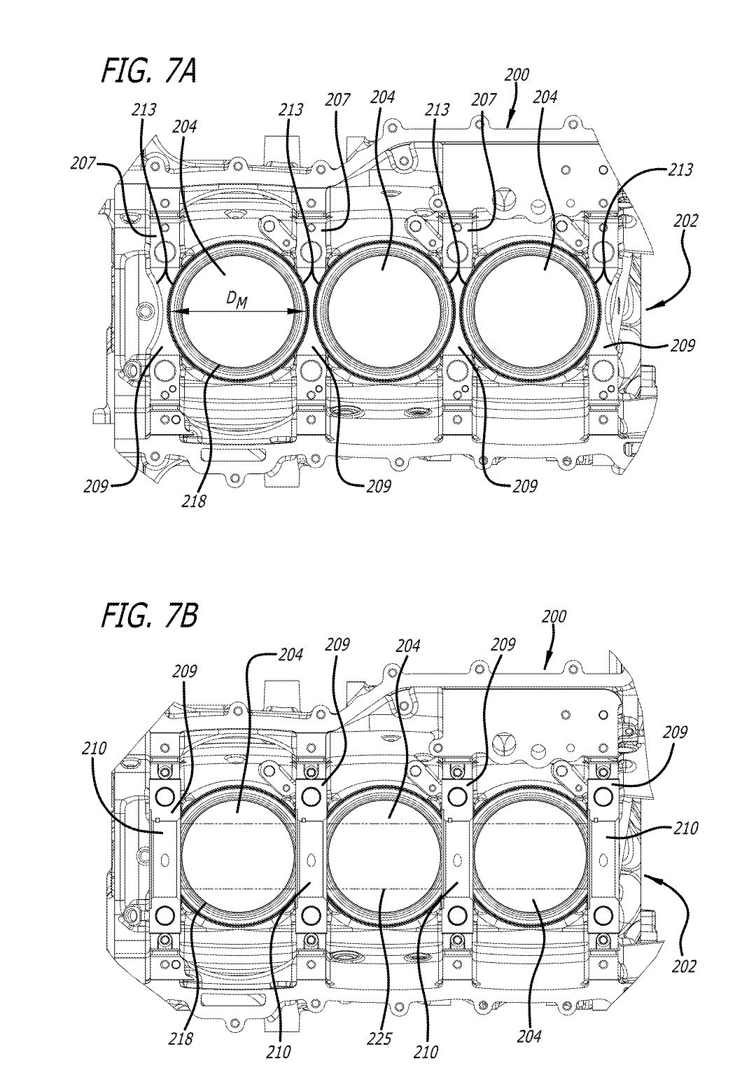

With reference to FIGS. 7A and 7B, a cylinder block 200 of an opposed-piston engine includes a plurality of bulkheads 207 which extend from a first crankcase 202 to a second crankcase (not seen). Cylinder spaces are defined in the cylinder block 200 between pairs of the bulkheads 207. Each bulkhead 207 comprises an end portion 209 disposed at the crankcase 202. Each end portion 209 can have at least one scalloped side; in the embodiment illustrated in FIGS. 7A and 7B, scalloping 213 is provided on each side of each end portion 209. The scallopings 213 of adjacent bulkheads 207 are complementary in that they define a generally circular aperture 204 having a diameter of at least D_{M}. As seen in FIG. 7B, a main bearing device 210 according to this specification is removably mounted to (or secured on) each end portion 209 in a manner illustrated in FIGS. 3 and 5C.

A cylinder liner 218 having a construction corresponding to that illustrated in FIG. 2 can be accessed in the cylinder block 200 through the crankcase 202 without splitting the cylinder block or detaching the crankcase from it. Per FIG. 7A, access through the crankcase 202 can be provided by way of generally circular apertures 204 between complementarily-scalloped portions 209 of two adjacent bulkheads 207 that flank and define a space shaped to receive a cylinder liner 218. In the absence of the main bearing devices 210 on the bulkheads 207, the complementary scalloping 213 can define and provide an unobstructed, generally circular aperture 204 large enough to allow passage of a large diameter D_{M} that characterizes a thickened intermediate portion of a cylinder liner 218 having a construction corresponding to that illustrated in FIG. 2, thereby enabling insertion and removal of the cylinder liner 218 through the crankcase, without splitting the cylinder block 200 or removing the crankcase from it. When assembled to the bulkheads as shown in FIG. 7B, the main bearing devices 210 overlay the complementary scalloping 213, thereby obstructing or blocking the aperture 204 so as to anchor, secure, or otherwise retain the cylinder liner 218 in the cylinder space defined between the bulkheads 207. So assembled, the main bearing devices 110 can support the main journals of a crankshaft 225.

The preferred application of the described main bearing device is in opposed-piston engines with two crankshafts and engine blocks which receive one or more cylinder liners (“a cylinder liner”) with thick intermediate portions as shown in FIG. 2. Incorporation of the novel main bearing device and apparatus according to this specification may ultimately have wide ranging impacts on construction, assembly, installation, and maintenance of such opposed-piston engines, which can hasten their acceptance in the marketplace.

Changes to, variations on, and/or adaptations of the disclosed embodiments may occur to a person having reasonable skill in the art of opposed-piston engines without departing from its scope and spirit, which is defined in the following claims.

1. A cylinder block of an opposed-piston engine, comprising:
a plurality of bulkheads extending between two crankcases of the cylinder block; and,
a pair of said bulkheads defining a cylinder space in the cylinder block, each bulkhead of said pair of bulkheads comprising a scalloped end portion at one crankcase of the two crankcases;
wherein the scalloped end portions of the pair of bulkheads defining an aperture configured for insertion of a cylinder liner with a thickened intermediate portion through the one crankcase without detaching the crankcase from the cylinder block.

2. The cylinder block of claim 1, further comprising:
a pair of main bearing devices, each main bearing device being configured to be removably mounted to a scalloped end portion of a bulkhead;
wherein when each main bearing device is removed from the scalloped end portion of the respective one of the pair of bulkheads, the aperture is unobstructed so as to permit the cylinder liner to be inserted into the cylinder space; and,
wherein, when each of the main bearing devices is mounted to the scalloped end portion of a respective one of the pair of bulkheads, the aperture is obstructed so as to prevent removal of the cylinder liner from the cylinder space.

3. The cylinder block of claim 2, wherein each main bearing device of the pair of main bearing devices comprises:
a saddle piece having a receiving surface with a first semi-cylindrical bearing recess and an attachment surface opposite the receiving surface and overlaying a respective scalloped end portion;
a cap piece having a second semi-cylindrical bearing recess, wherein the cap piece is configured to be received on the receiving surface such that the second semi-cylindrical bearing recess and the first semi-cylindrical bearing recess align to define a cylindrical bearing recess for a crankshaft main journal; and,
a plurality of fasteners which engage the saddle piece together with the cap piece and secure the saddle piece and cap piece to the respective scalloped end portion.

4. The cylinder block of claim 3, the plurality of fasteners comprising:
at least two studs passing through the saddle piece and cap piece of each main bearing device, into the bulkhead, one stud on each side of the cylindrical bearing recess, which join the saddle piece with the cap piece, and secure the joined saddle piece and cap piece to the bulkhead when the attachment surface is received on the respective shaped end portion.

5. The cylinder block of claim 4, further comprising at least two opposing cross bolts passing through the cylinder block into either the saddle piece or the cap piece of each main bearing device.

6. The cylinder block of claim 1, in which the thickened intermediate portion of the cylinder liner comprises an outer surface with a diameter D_{M} that is larger than a next largest outer diameter of an outer surface of either or each of two end portions of the cylinder liner.

7. The cylinder block of claim 3, in which the saddle piece of each main bearing device has a length which is greater than a corresponding length of the cap piece.

8. The cylinder block of claim 7, the plurality of fasteners of each main bearing device comprising at least two first studs configured to pass through the saddle piece and cap piece, one first stud on each side of cylindrical bearing recess, into the bulkhead, wherein a first end of each first stud is configured to be coupled to the cap piece and a second end of each first stud is configured to be threaded into the bulkhead.

9. The cylinder block of claim 8, the plurality of fasteners further comprising at least two second studs configured to pass through the saddle piece alone, one second stud on each side of cylindrical bearing recess, wherein a first end of each second stud is configured to be coupled to the saddle piece and a second end of each second stud is configured to be threaded into the bulkhead.

10. The cylinder block of claim 9, wherein the plurality of fasteners further includes at least two opposing cross bolts configured to pass through the cylinder block into either the saddle piece or the cap piece.

11. A cylinder block of an opposed-piston engine, comprising:
a plurality of bulkheads extending between two crankcases of the cylinder block; and,
a pair of said bulkheads defining a cylinder space in the cylinder block, each bulkhead of said pair of bulkheads comprising a shaped end portion at one crankcase of the two crankcases; and,
wherein the shaped end portions of the pair of bulkheads being configured to define a circular aperture that allows insertion, through the one crankcase, into the cylinder space, of a cylinder liner having a tubular shape comprising an intermediate portion between two end portions; and,
wherein the intermediate portion has a cylindrical shape with an outer surface diameter D_{M} that is greater than an outer diameter D_{E} of outer surfaces of the two end portions.

12. The cylinder block of claim 11, further comprising:
a pair of main bearing devices, each main bearing device being configured to be removably mounted to a shaped end portion of a bulkhead;
wherein when each main bearing device is removed from the shaped end portion of the respective one of the pair of bulkheads, the aperture is unobstructed so as to permit the cylinder liner to be inserted into the cylinder space without detaching the one crankcase from the cylinder block; and,
wherein, when each of the main bearing devices is mounted to the shaped end portion of a respective one of the pair of bulkheads, the aperture is obstructed so as to retain the cylinder liner in the cylinder space.

13. The cylinder block of claim 12, wherein each main bearing device of the pair of main bearing devices comprises:
a saddle piece having a receiving surface with a first semi-cylindrical bearing recess and an attachment surface opposite the receiving surface and overlaying a respective scalloped end portion;
a cap piece having a second semi-cylindrical bearing recess, wherein the cap piece is configured to be received on the receiving surface such that the second semi-cylindrical bearing recess and the first semi-cylindrical bearing recess align to define a cylindrical bearing recess for a crankshaft main journal; and,
a plurality of fasteners which engage the saddle piece together with the cap piece and secure the saddle piece and cap piece to the respective scalloped end portion.

14. The cylinder block of claim 13, the plurality of fasteners comprising:
at least two studs passing through the saddle piece and cap piece of each main bearing device, into the bulkhead, one stud on each side of the cylindrical bearing recess, which join the saddle piece with the cap piece, and secure the joined saddle piece and cap piece to the bulkhead when the attachment surface is received on the respective shaped end portion.

15. The cylinder block of claim 14, further comprising at least two opposing cross bolts passing through the cylinder block into either the saddle piece or the cap piece of each main bearing device.

16. The cylinder block of claim 13, in which the saddle piece of each main bearing device has a length which is greater than a corresponding length of the cap piece.

17. The cylinder block of claim 16, the plurality of fasteners of each main bearing device comprising at least two first studs configured to pass through the saddle piece and cap piece, one first stud on each side of cylindrical bearing recess, into the bulkhead, wherein a first end of each first stud is configured to be coupled to the cap piece and a second end of each first stud is configured to be threaded into the bulkhead.

18. The cylinder block of claim 17, the plurality of fasteners further comprising at least two second studs configured to pass through the saddle piece alone, one second stud on each side of cylindrical bearing recess, wherein a first end of each second stud is configured to be coupled to the saddle piece and a second end of each second stud is configured to be threaded into the bulkhead.

19. The cylinder block of claim 18, wherein the plurality of fasteners further includes at least two opposing cross bolts configured to pass through the cylinder block into either the saddle piece or the cap piece.

20. In an opposed-piston engine cylinder block comprising two crankcases, an improvement, comprising:
a main bearing device comprising a saddle piece and a cap piece which define a cylindrical bearing recess for a crankshaft main journal when fastened together; and,
stud means for fastening the saddle piece together with the cap piece, and for securing the saddle piece and cap piece to a shaped bulkhead end portion in a crankcase of the cylinder block.
